(19) United States
(12) Patent Application Publication
(10) Pub. No.: US 2005/0121365 A1
(43) Pub. Date: Jun. 9, 2005

(54) Process for removal of sulfur compounds from a fuel cell feed stream

(76) Inventors: Eric Jamie Weston, Shepherdsville, KY (US); David C. Wolfe, Louisville, KY (US); Michael W. Balakos, Buckner, KY (US); Jon P. Wagner, Louisville, KY (US); Kevin G. Northway, Greenville, IN (US)

Correspondence Address: Dr. Joan Simunic;SUD-CHEMIE INC., P. O. Box 32370, 1600 West Hill Street, Louisville, KY, 40232, US

(21) Appl. No.: 11/036,114

(22) Filed: Jan. 14, 2005

Related U.S. Application Data
(62) Division of application No. 10/260,362, filed on Sep. 30, 2002.

(51) Int. Cl. C10G 25/00; H01M 8/06

(52) U.S. Cl. 208/226; 208/244; 208/245; 429/19

(57) ABSTRACT

A process for the desulfurization of a fuel cell feed stream, wherein a sulfur contaminated hydrocarbon feed stream within a fuel cell system is desulfurized by passing it over a catalyst adsorbent containing from about 30 percent to about 80 percent nickel or a nickel compound, from about 5 percent to about 45 percent silica as a carrier, from about 1 percent to about 10 percent alumina as a promoter and from about 0.01 percent to about 15 percent magnesia as a promoter. The invention also includes a fuel cell system utilizing this catalyst adsorbent.

### CROSS REFERENCE TO RELATED APPLICATIONS

This application is a divisional application of application Ser. No. 10/260,362, filed on Sep. 30, 2002.

### BACKGROUND OF INVENTION

The present invention relates to a novel catalyst adsorbent for removal of sulfur compounds from liquid and gas feed streams, specifically a catalyst adsorbent for removal of sulfur compounds from hydrocarbon, petroleum distillate, natural gas, liquid natural gas and liquefied petroleum gas feed streams for refinery and particularly for fuel cell applications and methods of manufacture of the catalyst adsorbent.

### BACKGROUND ART

In a conventional fuel cell processing system, which is suitable for use in a stationary application or in a vehicle, such as an automobile, the fuel feed can be any conventional fuel, such as gasoline. A fuel pump delivers the fuel into the fuel cell system where it is passed over a desulfurizer bed to be desulfurized. The desulfurized fuel then flows into a reformer wherein the fuel is converted into a hydrogen-rich feed stream. From the reformer the feed stream passes through one or more heat exchangers to a shift converter where the amount of hydrogen in the feed stream is increased. From the shift converter the feed stream again passes through various heat exchangers and then through a selective oxidizer having one or more catalyst beds, after which the feed stream flows to the fuel cell where it is utilized to generate electricity.

Raw fuel, such as natural gas, gasoline, diesel fuel, naphtha, fuel oil, liquified natural gas and liquified petroleum gas, and like hydrocarbons, are useful for a number of different processes, particularly as a fuel source, and most particularly for use in a fuel cell power plant. Virtually all of these raw fuels contain relatively high levels of naturally occurring, organic sulfur compounds, such as, but not limited to, sulfides, mercaptans and thiophenes. These sulfur compounds may poison components of the fuel cell. In addition, hydrogen generated in the presence of such sulfur compounds has a poisoning effect on catalysts used in many chemical processes, particularly catalysts used in fuel cell processes, resulting in the formation of coke on the catalysts, thus shortening their life expectancy. When present in a feed stream in a fuel cell process, sulfur compounds may also poison the fuel cell stack itself.

Because of the relatively high levels of sulfur compounds that may be present in many raw fuel feed streams, it is necessary that these feed streams be desulfurized. An efficient desulfurization catalyst adsorbent is especially important in fuel cell systems which generally only contain a single desulfurization bed and which may be in use for an extended period of time.

Several processes, conventionally termed “desulfurization,” have been employed for the removal of sulfur from gas and liquid fuel streams. Adsorption of sulfur-contaminated compounds from these feed streams using a sulfur adsorbent is the most common method for removal of these sulfur compounds because of the high performance and relatively low capital and operational costs of these adsorbents.

Many different adsorbents have been useful as desulfurization agents, particularly for fuel cells. For example, U.S. Pat. No. 5,302,470 discloses the use of copper oxide, zinc oxide and aluminum oxide as desulfurization agents within a fuel cell system. Similarly, U.S. Pat. No. 5,800,798 discloses the use of alumina and magnesia as carriers for a copper-nickel desulfurization agent for use in fuel cells.

Other patents disclose the use of generic desulfurization agents for fuel cell processes but often fail to provide a significant description of the particular desulfurization agents. For example, U.S. Pat. No. 5,149,600 discloses a generic nickel on alumina desulfurization agent for fuel cells without disclosing any preferred embodiment. Similarly, U.S. Pat. No. 5,928,980 discloses a method for desulfurization, wherein the agent includes zinc and/or iron compounds. Further, U.S. Pat. No. 6,083,379 discloses a process by which gasoline is desulfurized by means of a commercially available zeolite used with various promoters, most notably magnesium oxide, wherein the binder is an alumina. In addition, U.S. Pat. No. 6,159,256 discloses a method for desulfurizing a fuel stream using an iron oxide carrier with a nickel reactant, though it does not specifically list what form of nickel is used. See also U.S. Pat. Nos. 5,302,470, 5,686,196, 5,769,909, 5,800,798, 6,162,267, 6,183,895, 6,190,623 and 6,210,821.

In a non-fuel cell process U.S. Pat. No. 5,026,536 discloses a process for producing hydrogen from hydrocarbons. The hydrocarbon feed is contacted by a nickel containing sorbent which may contain small quantities of copper, chromium, zirconium, magnesium and other metal components. A suitable carrier for the sorbent is selected from silica, alumina, silica-alumina, titania and other refractory oxides.

U.S. Pat. No. 5,348,928 discloses the use of molybdenum, cobalt, magnesium, sodium and an alumina component for purifying a fuel stream.

U.S. Pat. No. 5,914,293 discloses the use of microcrystallites composed of certain bi-valent metals, most notably magnesium, for desulfurization of a fuel stream. However, the high cost of the adsorbent as a result of the utilization of certain expensive additive metals limits the utility of these adsorbents to products where cost is not a factor. Further, the efficiency of these products is too low for commercial use.

U.S. Pat. No. 4,557,823 discloses a sulfur adsorbent containing a support selected from the group consisting of alumina, silica and silica-alumina. A promoter is added to the adsorbent which is selected from iron, cobalt, nickel, tungsten, molybdenum, chromium, manganese, vanadium and platinum, with the preferred promoter chosen from the group consisting of cobalt, nickel, molybdenum and tungsten. The preferred embodiment comprises an Al₂O₃ support promoted by CoO and MoO₃ or CoO, NiO and MoO₃. In these embodiments, the percentage of nickel used in the product is too low for it to be a significant adsorber of sulfur. Further, the percentage of sulfur removed from the fuel stream using this product is too low for many uses.

There are numerous other patents which disclose sulfur adsorbents for use with conventional hydrocarbon feed streams. For example, U.S. Pat. No. 5,322,615 discloses an adsorbent which consists of nickel metal on an inorganic oxide support. U.S. Pat. No. 4,613,724 discloses the use of zinc oxide/alumina or zinc oxide/aluminosilicate compositions for removing carbonyl sulfide from a liquid olefinic feedstock. For lowering sulfur levels in gas streams to ultra low levels and for protection of catalytic reforming catalysts, many of these desulfurization processes require elevated temperature ranges from about 70° C. up to about 500° C.

The most widely used physical adsorbents for sulfur compounds are synthetic zeolites or molecular sieves. For example, U.S. Pat. Nos. 2,882,243 and 2,882,244 disclose the use of molecular sieves, NaA, CaA and MgA as adsorbents for hydrogen sulfide at ambient temperatures. See also U.S. Pat. Nos. 3,760,029, 3,816,975, 4,540,842, 4,795,545 and 4,098,694.

These zeolite and molecular sieve physical adsorbents can work at ambient temperature and have a substantial capacity for removal of sulfur compounds at relatively high concentrations. The main disadvantage of these adsorbents is their inability to provide significant levels of sulfur removal (down to levels of less than 1 ppm) that some applications like deodorization, catalyst protection and hydrogen fuel preparation (especially for fuel cells) require.

While many of these products have shown some usefulness for gas and liquid feed stream purification of sulfur-contaminated compounds, it is important to provide improved catalyst adsorbents which do not possess the disadvantages mentioned above, especially for fuel cell applications.

Accordingly, it is an aspect of the invention to provide a catalyst adsorbent for desulfurization of a sulfur-contaminated feed stream, especially for fuel cells, with enhanced adsorption capacity over an extended range of sulfur concentrations.

It is a still further aspect of the invention to disclose a catalyst adsorbent, especially for fuel cells, with capability to purify feed streams of practically all organo-sulfur compounds, including, but not limited to, thiols (mercaptans), sulfides, disulfides, sulfoxides, thiophenes, etc, as well as hydrogen sulfide, carbon oxysulfide, and carbon disulfide, individually or in combination thereof.

It is a still further aspect of the invention to disclose a catalyst adsorbent for sulfur contaminated feed streams, especially for fuel cells, whose performance is enhanced over the performance of a conventional sulfur adsorbent nickel catalyst.

It is a still further aspect of the invention to disclose a catalyst adsorbent for sulfur contaminated feed streams with enhanced adsorption capacity, specifically designed for use within fuel cells.

It is a still further aspect of the invention to disclose an improved nickel catalyst adsorbent for desulfurization of a sulfur contaminated feed stream, especially for fuel cells, wherein the catalyst adsorbent shows enhanced nickel dispersion, enhanced nickel surface area and enhanced pore volume.

It is a still further aspect of the invention to provide a sulfur adsorbent, especially for fuel cells, that exhibits less “coking” during utilization, thereby increasing the life expectancy of the adsorbent.

These and further aspects of the invention will be apparent from the foregoing description of a preferred embodiment of the invention.

### SUMMARY OF INVENTION

The present invention is a catalyst adsorbent for removing sulfur compounds from sulfur contaminated gas and liquid feed streams, especially for use in fuel cell processes, comprising from about 30 percent to about 90 percent of metallic nickel or a nickel compound, from about 5 percent to about 45 percent of a silicon compound, preferably silica, used as a carrier, from about 1 percent to about 10 percent of an aluminum compound, preferably alumina, as a promoter, and from about 0.01 percent to about 15 percent of an alkaline earth compound, preferably magnesia, as an additional promoter, wherein all percentages are by weight.

The invention is also a process for the manufacture of a sulfur adsorbent catalyst, especially for use in fuel cells, comprising preparing a precursor catalyst adsorbent material comprising a nickel compound deposited on a silica carrier and further comprising an alumina promoter and an alkaline earth promoter, drying the precursor material at a temperature from about 180° C. to about 220° C., and reducing the dried material at a temperature from about 315° C. to about 485° C. to produce the catalyst adsorbent. In an alternative process, instead of drying the precursor material at temperatures from about 180° C. to about 220° C., the precursor material can be calcined at temperatures from about 370° C. to about 485° C. prior to the reduction step.

### DISCLOSURE OF THE INVENTION

The desulfurization catalyst adsorbent of the present invention is preferably comprised of a metallic nickel or nickel compound deposited on a silica carrier with at least two promoters, wherein the preferred promoters comprise an aluminum compound and an alkaline earth compound. The nickel or nickel compound comprises from about 30 percent to about 90 percent by weight, preferably about 50 percent to about 80 percent by weight and most preferably from about 60 to about 70 percent by weight of the catalyst adsorbent.

The nickel precursor material is generally produced by a conventional precipitation and drying process as discussed later. After precipitation, if the nickel precursor material is dried at a temperature from about 180° C. to about 220° C., the resulting nickel compound formed preferably comprises a nickel carbonate, most preferably a nickel hydroxy carbonate, such as Ni₈(OH)₄(CO₃)₂. It has been surprisingly discovered that useful catalyst adsorbents can be produced using this nickel hydroxy carbonate as the precursor nickel compound. Once the nickel hydroxy carbonate is produced, it may be reduced either in situ or prior to shipping at a temperature from about 315° C. to about 485° C.

In an alternative procedure, instead of drying the nickel precursor material at relatively low temperatures of about 180° C. to about 220° C., it can be directly calcined at a temperature from about 700° F. (370° C.) to about 900° F. (485° C.), and preferably at about 800° F. (427° C.) in air for about 8 hours to produce a nickel oxide precursor material. This nickel oxide material may then be reduced either in situ or prior to shipping at a temperature from about 600° F. (315° C.) to about 900° F. (485° C.), and preferably at about 750° F. (400° C.) for about 16 hours.

It has been surprisingly discovered that nickel catalyst adsorbents produced using the nickel carbonate precursor material may exhibit slightly better performance than catalysts produced from the alternative nickel oxide precursor material. It has also been surprisingly discovered that nickel catalyst adsorbents produced from the nickel oxide precursor material may have superior physical characteristics to catalyst adsorbents produced from the nickel carbonate precursor material in that they are stronger and thus better able to be formed into shapes with a longer life expectancy while still exhibiting high performance. Regardless, each of these catalyst adsorbents exhibit high performance in comparison to prior art catalyst adsorbents.

Suitable carrier materials for the nickel or nickel compound include silica, alumina, silica-alumina, titania, zirconia, zinc oxide, clay, diatomaceous earth, magnesia, lanthanum oxide, alumina-magnesia and other inorganic refractory oxides. The preferred carrier, however, is formed from silica. The carrier component comprises from about 5 percent to about 25 percent by weight, preferably from about 10 percent to about 20 percent by weight, and most preferably from about 12 percent to about 16 percent by weight of the catalyst adsorbent. The primary function of the “carrier” is to spread out the active nickel component to provide a large and accessible surface area for deposition of the nickel compound. Many conventional nickel desulfurization compounds have been produced by depositing a nickel component on an alumina or a part alumina carrier, such as is disclosed in U.S. Pat. Nos. 5,853,570, 5,149,660 and 5,130,115. However, it has been surprisingly discovered that a superior desulfurization catalyst adsorbent is produced where the carrier is a silica compound, especially one produced from diatomaceous earth. The nickel compound of the invention is preferably deposited on the silica carrier using a conventional deposition process, preferably by precipitation. In the precipitation process a nickel salt, such as nickel nitrate, is mixed with the catalyst carrier. The salt is precipitated from the solution preferably using an alkali carbonate, such as sodium carbonate or potassium carbonate. The pH of the resulting solution is maintained at slightly basic level of around 7.5 to 9.5. The temperature of the resulting slurry is maintained at about 100° F. to about 150° F. (38° C. to 65° C.) during precipitation. Following precipitation, the precipitated catalyst is washed until the alkali level is less than 0.1 percent in the precipitated slurry. The washed precursor catalyst material is then dried at about 180° C. to about 220° C. (if the nickel carbonate precursor is to be prepared) or calcined at about 370° C. to about 485° C. (if the nickel oxide precursor process is to be prepared).

The performance of the nickel catalyst adsorbent of the invention is improved by the addition of promoters. A “promoter” alters the properties of the active phase of a catalyst adsorbent. Promoters can also enhance structural characteristics, such as sintering ability, or chemical properties, such as increasing reaction rate. “Promoters” are categorically distinct from “carriers.” The promoters of the inventive catalyst adsorbent are preferably at least an aluminum compound, preferably aluminum oxide, and an alkaline earth material, preferably a magnesium compound, most preferably magnesium oxide.

The promoter, and other additives for the nickel catalyst adsorbent, can be coprecipitated with the nickel compound as precursor materials, such as nitrate precursors, onto the carrier material or they can be precipitated separately. If the promoters are coprecipitated, the desired promoter precursor materials, such as the nitrate precursors, are mixed with the nickel salt and the catalyst carrier material in an aqueous solution at the appropriate concentrations to produce the desired end product.

In a preferred embodiment, the aluminum promoter compound, preferably aluminum oxide, comprises from about 1 percent to about 10 percent of the catalyst adsorbent by weight, preferably from about 2 percent to about 10 percent, most preferably from about 5 percent to about 9 percent by weight. While the use of an aluminum compound, such as aluminum oxide, as a promoter is preferred, other similar oxide materials such as ceria, zirconia, titania and zinc oxide may be substituted for, or used in combination with the alumina in the catalyst adsorbent, although alumina provides the best performance.

The alkaline earth material, which is preferably a magnesium compound, most preferably magnesium oxide, comprises from about 0.01 percent to about 15 percent, preferably from about 0.05 percent to about 10 percent of the catalyst adsorbent by weight, and in one preferred embodiment from about 0.1 percent to about 1.0 percent by weight of the catalyst adsorbent. While magnesium oxide is the preferred promoter, other alkaline earth metal oxides, such as calcium oxide, may be substituted for, or used in combination with, magnesium oxide although the presence of magnesium oxide produces an adsorbent with better performance. In a preferred process these promoter materials are mixed in the form of a salt solution, such as a nitrate, with the carrier for the catalyst adsorbent and the nickel salt in solution prior to formation of the end product, as discussed above.

Other additive compounds, such as oxides of other alkaline earth metals, may also be added to the catalyst adsorbent. For example, calcium, barium, zinc, tin, and the oxides thereof, such as calcium oxide, borium oxide, zinc oxide and tin oxide may also be added. In a preferred embodiment, the additional additive, if one is used, is calcium oxide. These additional additive materials may be added to the catalyst by mixing with the nickel material, catalyst carrier and other additives in the form of a salt, such as a nitrate, prior to calcination to an oxide form.

Once the catalyst adsorbent of the invention is prepared, it is formed into a shape that is useful as a sulfur adsorber. The catalyst adsorbent can be formed in any conventional shape, such as a powder, extrudate, sphere or tablet. However, for use as a desulfurization agent with a conventional gaseous or liquid feed stream, the nickel adsorbent catalyst of the invention is preferably formed into a shape providing significant surface area. For example, the catalyst adsorbent of the invention can be formed into a monolithic structure or a foam by a conventional forming procedure.

It has been surprisingly discovered that when the catalyst adsorbent of the invention is formed comprising nickel or a nickel compound on a silica carrier with alumina and magnesia as promoters, it has an enhanced nickel surface area of at least about 40 m²/g and preferably from about 40 m²/g to about 60 m²/g. Conventional nickel adsorbents have a nickel surface area of only about 25 m²/g to about 35 m²/g.

It has also been surprisingly discovered that the dispersion of the nickel on the catalyst adsorbent of the invention is enhanced by the composition of the adsorbent. While conventional nickel desulfurization catalysts have a nickel dispersion of about 7 percent to about 11 percent, the dispersion of the nickel on the catalyst adsorbent of the invention is increased to a range of from about 8 percent to 16 percent. The method of confirming this dispersion is as follows:

Micromeritics ASAP 2010C (Accelerated Surface Area and Porosimetry System)

Method as follows:

(1) 0.2 to 0.3 grams of powdered sample is pretreated in hydrogen (˜30 cc/min flow) and the temperature is ramped from room temperature to 450° C. at a rate of about 10° C./min.

(2) The sample is reduced for two hours under hydrogen at a temperature of 450° C.

(3) After reduction, the sample cell is evacuated for 80 minutes at 460° C. and then cooled to 30° C. (cooling rate ˜10° C./min) under vacuum.

(4) Two adsorption isotherms are measured at 30° C., up to 600 torr, with one hour of evacuation between each. The volume of chemisorbed hydrogen is determined from the difference between the isotherms, extrapolated to 0 torr.

(5) The amount of reduced nickel metal is determined by oxygen titration at 450° C., determined by measuring one adsorption isotherm up to 600 torr and extrapolating the flat portion of the curve to 0 torr.

In addition to an enhanced nickel surface area and nickel dispersion, the pore volume of the catalyst adsorbent of the invention is also enhanced over conventional nickel catalyst adsorbents. Whereas a conventional nickel catalyst adsorbent has a pore volume of about 0.35 cc/g to about 0.45 cc/g, the pore volume of the catalyst adsorbent of one embodiment of the invention is at least about 1.0 cc/g and preferably from about 1.2 cc/g to about 2.2 cc/g, as determined by using a conventional mercury test, as known in the art.

It has also been surprisingly discovered that the catalyst produced from the composition of the invention may be effectively reduced at a lower temperature of about 750° F. (400° C.) than conventional sulfur adsorbent catalysts, which must be reduced at a temperature of about 850° F. (455° C.). Catalysts of the invention, which are reduced at this lower temperature (750° F. (400° C.)), perform almost as well as catalysts of the invention which are reduced at the conventional, higher temperature of about 850° F. (455° C.). In contrast, conventional nickel catalyst adsorbents, which are reduced at a lower temperature of about 750° F. (400° C.), perform significantly worse than those same conventional nickel adsorbent catalysts which are reduced at higher temperature levels of about 850° F. (455° C.). This is a significant advantage for catalysts of the invention because many sulfur adsorbent catalysts are reduced in situ and it is often difficult, and always more expensive, to reduce the catalyst adsorbent at the conventional higher temperatures of about 850° F. (455° C.).

It has also been surprisingly discovered that by use of the composition of the desulfurization catalyst adsorbent of the invention, there is also a reduction in the coke deposition caused by olefin polymerization and stable desulfurization activity can be maintained for a longer period of time.

In addition, it has also been surprisingly discovered that the effective life of the catalyst adsorbent is extended. By using the nickel desulfurization catalyst adsorbent of the invention, the amount of sulfur in the feed stream is significantly lowered to a level which does not adversely effect the utilization of the feed stream. The amount of sulfur in the feed stream is reduced to a level which also does not adversely affect the other components or process steps, such as the components of a fuel cell process including the reformer, selective oxidizer, shift converter and/or other components of a fuel cell assembly. As a result, raw fuels, which may possess relatively large quantities of organic sulfur compounds, such as gasoline, diesel fuel, lighter hydrocarbon fuels, such as butane, propane, natural gas and petroleum gas, or the like fuel stocks, can be safely used for an extended period of time as the reactant, for example in a fuel cell power plant that produces electricity to operate a vehicle.

In one use of the catalyst adsorbent of the invention, a sulfur contaminated hydrocarbon feed stream, especially for use in fuel cells, is passed over the catalyst adsorbent of the invention at a temperature from about 150° C. to about 205° C., a pressure from about 25 psig (172 kilopascals) to about 200 psig (1329 kilopascals) and a linear velocity from about 4 m/sec to about 8 m/sec. When the desulfurization catalyst adsorbent of the invention is utilized in a conventional liquid or gaseous feed stream where the level of the sulfur compounds is from about 0.1 ppm to about 10,000 ppm, there is a substantial reduction in the amount of sulfur compounds that are present in the feed stream, preferably down to a level of less than about 100 ppb.

The present invention is generally applicable to adsorption of a broad range of sulfur compounds that may be present in a conventional feed stream, especially a feed stream of a fuel cell. The adsorbent catalyst of the invention is a more effective adsorbent for sulfur compounds in a feed stream for fuel cells over a longer period of time than conventional commercial catalyst adsorbents. Further, the catalyst adsorbent of the invention is capable of adsorbing a greater quantity of sulfur from the feed stream and is able to reduce the amount of the sulfur present in the feed to acceptable levels for a longer period of time than conventional commercial sulfur catalyst adsorbents.

As many changes and variations of the disclosed embodiment may be made without departing from the invented concept, the invention is not intended to be limited otherwise than as required by the intended claims.

1. A process for desulfurization of a hydrocarbon feed stream within a fuel cell system comprising;
providing a sulfur contaminated, hydrocarbon feed stream to the fuel cell system;
passing the sulfur contaminated, hydrocarbon feed stream over a catalyst adsorbent comprising nickel or a nickel compound deposited on a silica carrier and further comprising an alumina promoter, and an alkaline earth compound promoter to produce a substantially desulfurized hydrocarbon feed stream, and
delivering these substantially desulfurized hydrocarbon feed stream to remaining components of the fuel cell system.

2. The process of claim 1 wherein the alkaline earth compound comprises magnesium oxide.

3. The process of claim 1 wherein the nickel or nickel compound comprises from about 30 percent to about 90 percent of the catalyst adsorbent, by weight.

4. The process of claim 1 wherein the silica carrier comprises from about 5 percent to about 25 percent of the catalyst adsorbent, by weight.

5. The process of claim 1 wherein the alumina promoter comprises from about 1 percent to about 10 percent of the catalyst adsorbent, by weight.

6. The process of claim 1 wherein the alkaline earth compound promoter comprises from about 0.01 percent to about 15 percent of the catalyst adsorbent, by weight.

7. The process of claim 1 wherein the nickel compound comprises a nickel carbonate.

8. The process of claim 1 wherein the nickel compound comprises a nickel hydroxy carbonate.

9. The process of claim 1 wherein the nickel compound comprises nickel oxide.

10. A fuel cell system comprising;
a source for a hydrocarbon feed;
a catalyst adsorbent for desulfurizing the hydrocarbon feed comprising nickel or a nickel compound deposited on a silica carrier, an alumina promoter and an alkaline earth compound promoter, and
additional fuel cell components comprising a reformer, a shift converter and a fuel cell stack.

11. The fuel cell system of claim 10 wherein the alkaline earth compound comprises magnesium oxide.

12. The fuel cell system of claim 10 wherein the nickel or nickel compound comprises from about 30 percent to about 90 percent of the catalyst adsorbent, by weight.

13. The fuel cell system of claim 10 wherein the silica carrier comprises from about 5 percent to about 25 percent of the catalyst adsorbent, by weight.

14. The fuel cell system of claim 10 wherein the alumina promoter comprises from about 1 percent to about 10 percent of the catalyst adsorbent, by weight.

15. The fuel cell system of claim 10 wherein the alkaline earth compound promoter comprises from about 0.01 percent to about 15 percent of the catalyst adsorbent, by weight.

16. The fuel cell system of claim 10 wherein the nickel compound comprises a nickel carbonate.

17. The fuel cell system of claim 10 wherein the nickel compound comprises a nickel hydroxy carbonate.

18. The fuel cell system of claim 10 wherein the nickel compound comprises nickel oxide.
